(19) United States
(12) Patent Application Publication
(10) Pub. No.: US 2014/0082497 A1
(43) Pub. Date: Mar. 20, 2014

(54) SYSTEM AND METHOD FOR BROWSING AND ACCESSING LIVE MEDIA CONTENT

(71) Applicant: Fanhattan LLC, San Mateo, CA (US)

(72) Inventors: Olivier Chalouhi, Redwood City, CA (US); Gilles Serge BianRosa, Redwood City, CA (US); Nicolas Paton, San Francisco, CA (US); William Jiang, San Jose, CA (US)

(73) Assignee: Fanhattan LLC, San Mateo, CA (US)

(21) Appl. No.: 14/029,481

(22) Filed: Sep. 17, 2013

Related U.S. Application Data
(60) Provisional application No. 61/702,128, filed on Sep. 17, 2012.

(51) Int. Cl. G06F 3/048

(52) U.S. Cl. CPC G06F 3/048
USPC 715/716

(57) ABSTRACT

A system and method for providing a user interface for live media content is described. A top portion of the user interface is populated with media content categories. A selection of a media content category from the media content categories is received. A bottom portion of the user interface is populated with at least one panel relating to the selection of media content category. A timeline comprising a progress indicator corresponding to a progress of a live media content associated with the at least one panel is generated in the user interface.

### CROSS-REFERENCE TO RELATED APPLICATION

This application claims the benefit of U.S. Provisional Patent Application Ser. No. 61/702,128, entitled “System and Method for Browsing and Accessing Live Media Content,” filed Sep. 17, 2012.

### TECHNICAL FIELD

Example embodiments of the present application generally relate to media content and, more specifically, to a system and method for browsing and accessing live media content.

### BACKGROUND

Navigating among a vast sea of content is a particularly difficult and burdensome task for a user. Today's user interfaces and search engines offer some insights and approaches to navigating among content, but often these interfaces and search engines are designed to navigate among content in a rigid manner.

### BRIEF DESCRIPTION OF DRAWINGS

The embodiments disclosed in the present disclosure are illustrated by way of example, and not by way of limitation, in the figures of the accompanying drawings. Like reference numerals refer to corresponding parts throughout the drawings.

FIG. 1 is a block diagram illustrating a network system having an architecture configured for exchanging data over a network, according to some embodiments.

FIG. 2 is a block diagram illustrating modules of an application, according to some embodiments.

FIG. 3 is a flow diagram illustrating an example method for efficient switching of contexts by which content is navigated, according to some embodiments.

FIG. 4 is a flow diagram illustrating an example method for pyramidal navigation of content, according to some embodiments.

FIG. 5 is a flow diagram illustrating an example method for power browsing of content, according to some embodiments.

FIG. 6 is a flow diagram illustrating an example method for pivot navigation of content, according to some embodiments.

FIG. 7 is a block diagram of an example user interface for efficient switching of contexts by which content is navigated, according to some embodiments.

FIG. 8A is a block diagram of an example user interface for pyramidal navigation of content, according to some embodiments.

FIG. 8B is a block diagram of an example user interface for pyramidal navigation of content, according to some embodiments.

FIG. 8C is a block diagram of an example user interface for pyramidal navigation of content, according to some embodiments.

FIG. 9 is a block diagram of an example user interface for power browsing of content, according to some embodiments.

FIG. 10 is a flow diagram illustrating an example method for navigating live content.

FIG. 11 is a flow diagram illustrating another example method for navigating live content.

FIG. 12 is a block diagram of an example user interface for navigating live content.

FIG. 13 is a block diagram of another example user interface for navigating live content.

FIG. 14 is a block diagram of another example user interface for navigating live content.

FIG. 15 is a block diagram of another example user interface for navigating live content.

FIGS. 16-19 show screenshots of examples of a user interface for navigating live content.

FIG. 20 shows a diagrammatic representation of a machine in the example form of a computer system.

### DETAILED DESCRIPTION

Although the disclosure has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

In various embodiments, a system and method for navigating content is disclosed. A system and method for providing a user interface for live media content is described. A top portion of the user interface is populated with media content categories. A selection of a media content category from the media content categories is received. A bottom portion of the user interface is populated with at least one panel relating to the selection of media content category. A timeline comprising a progress indicator corresponding to a progress of a live media content associated with the at least one panel is generated in the user interface.

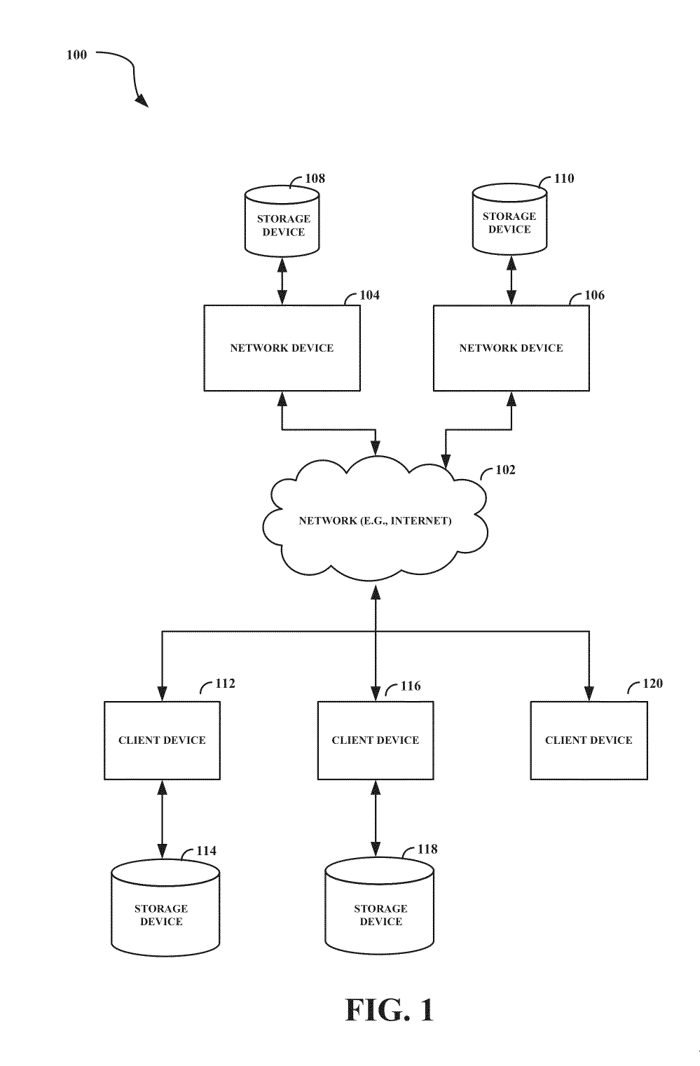

FIG. 1 is a block diagram illustrating an example network system 100 connecting one or more client devices 112, 116, and 120 to one or more network devices 104 and 106 via a network 102. The one or more client devices 112, 116, and 120 may include Internet- or network-enabled devices, such as consumer electronics devices (e.g., televisions, DVD players, Blu-Ray® players, set-top boxes, portable audio/video players, gaming consoles) and computing devices (e.g., personal computer, laptop, tablet computer, smart phone, mobile device). The type of client devices is not intended to be limiting, and the foregoing devices listed are merely examples. The client devices 112, 116, and 120 may have remote, attached, or internal storage devices 114, 118. Although client devices 112 and 116 are shown in FIG. 1 as having connected storage devices 114 and 118, respectively, client device 120 is shown without a connected storage device. However, in some embodiments, each client device 112, 116, and 120 may have local access to one or more storage or memory devices.

In some embodiments, one or more of the client devices 112, 116, and 120 may have installed thereon and may execute a client application (not shown) that enables the client device 112, 116 and 120 to serve as a local media server instance. The client application may search for and discover media content (e.g., audio, video, images) stored on the device 112, 116 and 120 as well as media content stored on other networked client devices having the client application installed thereon. The client application may aggregate the discovered media content, such that a user may access local content stored on any client device (e.g., 112, 116 and 120) having the client application installed thereon. In some embodiments, the aggregated discovered media content may be separated by a device, such that a user is aware of the network devices connected to a particular device and the content stored on the connected network devices. In some embodiments, each connected network device may be represented in the application by an indicator, such as an icon, an image, or a graphic. When a connected network device is selected, the indicator may be illuminated or highlighted to indicate that that particular network device is being accessed.

In some embodiments, the discovered media content may be stored in an aggregated data file, which may be stored on the client device 112, 116 and 120. The client device 112, 116 and 120, in which the content resides, may index the local content. The client application may also aggregate and present a variety of remote sources to the user from which the user is able to download, stream, or otherwise access a particular media content item. For example, the client application may present to the user all streaming, rental, and purchase options for a particular media content item to the extent they exist and are available for access.

One or more network devices 104 and 106 may be communicatively connected to the client devices 112, 116, and 120 via a network 102. In some embodiments, the network devices 104 and 106 may be servers storing media content or metadata relating to media content available to be accessed by the client devices 112, 116, and 120. In some embodiments, the network devices 104 and 106 may include proprietary servers related to the client application as well as third party servers hosting free or subscription-based content. Additional third-party servers may include servers operating as metadata repositories and servers hosting electronic commerce sites. For example, in the context of movies, third-party servers may be servers associated with the themoviedb.org and other third-party aggregators that store and deliver movie metadata in response to user requests. In some embodiments, some of the third-party servers may host websites offering merchandise related to a content item for sale. The network devices 104 and 106 may include attached storage devices or may interface with databases or other storage devices 108 and 110. For illustrative purposes only, the network devices 104 and 106 each have been shown as a single device in FIG. 1, although it is contemplated that the network devices 104 and 106 may include one or more web servers, application servers, database servers, and so forth, operating independently or in conjunction to store and deliver content via the network 102.

In some embodiments where one or more of the network devices 104 and 106 are proprietary servers associated with the client application, the proprietary servers may store metadata related to media content and data that facilitate identification of media content across multiple content servers. For example, the proprietary servers may store identifiers for media content that are used to interface with third party servers that store or host the media content. The proprietary servers may further include one or more modules capable of verifying the identity of media content and providing access information concerning media content (e.g., the source(s) of media content, the format(s) of media content, the availability of media content).

The client application installed on one or more of the client devices 112, 116, and 120 may enable a user to search for media content or navigate among categories of media content. To find media content, a user may enter search terms in a user interface of the client application to retrieve search results, or the user may select among categories and sub-categories of media content to identify a particular media content item. For each browsed content item, the client application may display metadata associated with the content item. The metadata may be retrieved from both local and remote sources. The metadata may include, but are not limited to, a title of the content item, one or more images (e.g., wallpapers, backgrounds, screenshots) or video clips related to the content item, a release date of the content item, a cast of the content item, one or more reviews of the content item, and release windows and release dates for various distribution channels for the browsed content item.

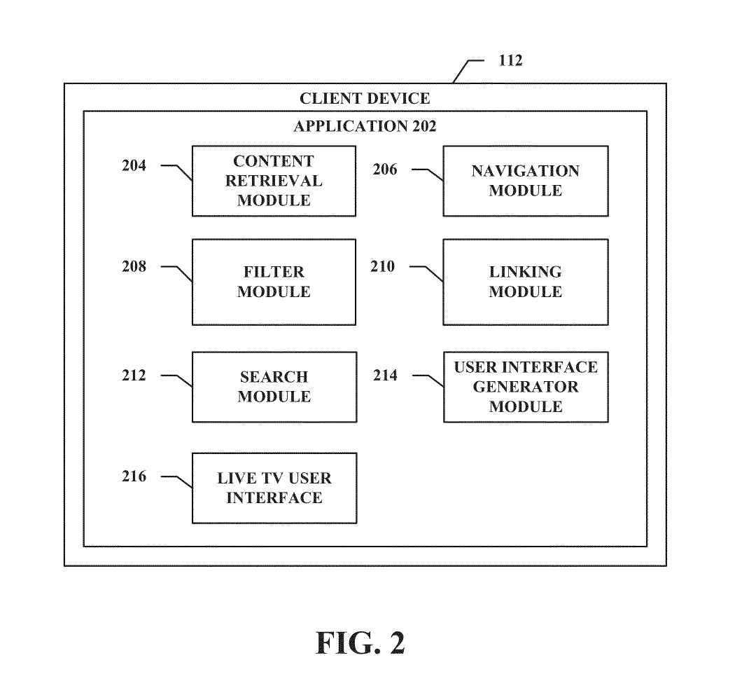

FIG. 2 is a block diagram illustrating modules of an application, according to some embodiments. Although the modules in FIG. 2 are shown as being part of a client device 112, it is contemplated that the modules may be implemented on a network device, such as a server. In an example embodiment, the application 202 may be the client application discussed with reference to FIG. 1. In an example embodiment, one or more processors of a client device 112, 116 and 120 or a network device 104, 106 may execute or implement the modules.

The application 202 includes modules, such as a content retrieval module 204, a navigation module 206, a filter module 208, a linking module 210, a search module 212, a user interface generator module 214, and a live TV user interface 216 to perform operations, according to some embodiments.

The content retrieval module 204 may retrieve content and content-related data from networked devices, such as content (e.g., live content or previously recorded content) sources and metadata repositories. Content sources may include both locally networked sources (e.g., other networked devices executing the application 202) and remote sources, such as third party content providers. In some embodiments, the content retrieval module 204 may retrieve metadata related to content items and may use the metadata to populate a user interface with information related to content items, such as movies and television programs. For example, the content retrieval module 204 may retrieve metadata such as a content titles, cover art, screenshots, content descriptions, plot synopses, and cast listings. In some embodiments, the metadata may be displayed as part of listings of content presented to a user during application navigation and search operations. For example, the metadata may be displayed when a user is navigating among categories of content or is searching for a particular content item. Each content item discovered during navigation or searching may be populated with the retrieved metadata. In some embodiments, metadata is retrieved on an as-needed basis. To reduce the number of data requests and conserve processing and bandwidth resources, metadata may be retrieved when a user navigates to a previously un-traversed portion of the user interface or when the displayed content changes due to a change in search or filtering criteria, among other things. In some embodiments, an AJAX or JSON call is executed to retrieve metadata from local or remote sources.

The navigation module 206 facilitates navigation and browsing of content made available by the application 202. The navigation module 206 may operate in one or more modes. In a carousel navigation mode, the navigation module 206 may provide a user with the ability to easily and efficiently switch the contexts by which content is navigated. For example, a first user interface panel may display a first context by which content items may be browsed. The first context may comprise filtering criteria related to “Top Movies.” Under the heading of “Top Movies,” the navigation module 206 may provide one or more sub-filters by which content may be browsed and surfaced. As a user traverses the sub-filters, content items displayed in a different portion of the user interface may change to reflect the changing criteria by which the content is being browsed. In some embodiments, the sub-filters for a heading of “Top Movies” may include, but are not limited to, “Hottest,” “Newest,” “Top Rated,” “Critics Picks,” and “Top Free.” The user interface panel may be designed to be traversed by directional arrows of a remote control or keyboard, by an input/output device, or by a touch-based computing device.

If the first user interface panel does not provide the context by which a user desires to navigate among content, the user may easily switch contexts by traversing in a left or right direction to a different context. The different context may be presented in its own user interface panel with selectable and traversable sub-filters or sub-contexts provided within the panel to filter the content items displayed in the content display portion of the user interface. For example, if a user cannot find a content item he wants to view in the “Top Movies” context, the user may change contexts to a “Genre” context. At the new context, the user may navigate among different genres and surface content items related to the selected genre.

The ease in which contexts may be switched is made possible by the fact that at any point in the context panel, the user may traverse right or left to switch contexts. In other words, the user is not required to return to a starting point in the user interface to switch contexts. The carousel nature of context switching is illustrated by the ability for a user to traverse right or left and has different context panels rotate and be presented in the user interface for navigating among content. Thus, the carousel nature of context switching enables a user to navigate among two hierarchies of content using four directions (e.g., up, down, left, right). For touch-enabled computing devices, navigation may be accomplished using touch-based gestures, such as horizontal and vertical swipes and taps.

In a second navigation mode, the navigation module 206 may facilitate a pyramidal navigation of content. Content may be presented to the user in a reverse pyramid hierarchy, with broad categories of content or aggregated content presented at a top-most level. In some embodiments, the top-most level may correspond with the carousel context switching panels. As a user traverses downward through the top-most level and reaches the last sub-element of the top-most level, the user may navigate from the top-most level to a middle-tiered level. In some embodiments, the middle-tiered level may feature one or more displayed content items. In some embodiments, the one or more content items may first be displayed in a lower portion of the user interface. Upon traversing from the top-most level to the middle-tiered level, the content items may transition from the lower portion of the user interface to the upper portion of the user interface. Thus, the content items may displace the top-most level user interface panels. In conjunction with such displacement, a set of user interface panels containing details for an individual content item may replace the content items in the lower portion of the user interface. A user may traverse left and right to navigate among the content items, and as the traversal occurs, the content item detail panels may be populated with information about the selected content item.

A further hierarchical traversal of content may occur when a user traverses from the middle-tiered level depicting content items to a bottom-tiered level depicting details about a particular content item. In some embodiments, the bottom-tiered level may feature one or more panels devoted to different details or aspects of the content item. In some embodiments, such panels may include a content item description panel, a cast panel listing the cast of the content item, a content source panel from which the content item may be viewed, a merchandise panel featuring merchandise related to the content item, a reviews panel featuring reviews of the content item, and a similar content items panel. The user may navigate between panels using motions in a first axis (e.g., horizontal motions, such as left and right arrow selections, horizontally-directed gestures). If the user selects one of the items displayed in the panel (e.g., a cast member, a merchandise item, a similar content item), the user may be directed to a new hierarchy involving the selected item. This is true for any panel. Thus, in this sense, the pyramidal navigation may begin anew and may not be bounded by a start and an end point.

A third navigational mode supported by the navigation module 206 may entail a power browsing mode whereby content may be browsed via a multi-dimensional search. A user interface panel may be presented with sub-categories and options within each sub-category. As a user proceeds through the panel and selects a sub-category and a choice within the sub-category, content items meeting the filtering criteria may be surfaced and displayed. As a user makes selections in multiple sub-categories, a multi-dimensional navigation mode is attained, thereby more quickly surfacing content items than by performing a single dimension search.

For example, a user first may select a sub-category “genre” and within the “genre” sub-category, the user may decide to select the “action and adventure,” “classics,” and “sci-fi and fantasy” genres. Accordingly, content items falling within any of the three selected genres may be displayed in the user interface. A user then may traverse downward in the power browsing panel to the next sub-category. In this example embodiment, the sub-category may be “user ratings.”

The user may select “2 or more stars,” in which case only those content items falling within one of the three selected genres and having a user rating of 2 or more stars may be displayed. The user may continue traversing down the power browsing panel and select a sub-category “release date,” and within the sub-category “release date,” the user may select “1990s.” Thus, only content items falling within the three selected genres having a user rating of 2 or more stars and a release date in the 1990s may be surfaced and displayed. The user may continue traversing the power browsing panel and adding additional dimensions to the filter in order to find the most relevant content items meeting the user's desired filter criteria. Once satisfied, the user may traverse to the displayed content items and select a particular content item for browsing and/or viewing.

A fourth navigational mode supported by the navigation module 206 may be pivot navigation, in which a user may use any piece of data related to a content item as a pivot point to discover data related to the data pivot. For example, if a user is browsing a particular content item and views the cast of the item, the user may select a particular cast member and use that cast member as a pivot point. At that point, the focus of the user interface may switch from the content item to the cast member. The user may then select a different content item featuring the cast member. That different content item may become the next pivot point for the user to discover related data. Thus, the user may browse among content-related data using specific data items as pivot points by which to discover additional related data.

While four navigational modes have been discussed herein, one of ordinary skill in the art should appreciate that, at any given state of the application, more than one navigation mode may be used together. In other words, the four navigational modes described herein are not to be considered as mutually exclusive navigational modes.

The filter module 208 may store and supply filters to the navigation module 206 for use in helping a user sort through content to identify specific content items of interest. In some embodiments, the filters may be pre-determined, while in other embodiments, the filters may be customized, such as for example, by the user. The filter module 208 may also receive filtering criteria selections from a user and may perform comparisons between the filtering criteria and metadata related to content items. In some embodiments, the filter module 208 may operate in conjunction with the content retrieval module 204 to retrieve only those content items meeting the filtering criteria. For example, in some embodiments, the filter module 208 may determine based on comparisons of metadata which content items meet the filtering criteria. The filter module 208 may pass the content items meeting the filtering criteria to the content retrieval module 204 for retrieval.

The linking module 210 may maintain one or more data structures that store links between content items and content item-related data. The links may facilitate pivot navigation among disparate pieces of data. In some embodiments, the linking module 210 may examine metadata related to content items to determine if any piece of metadata in one content item overlaps or is related to a piece of metadata from another content item. If an association between metadata of two content items exists, the linking module 210 may store the link between the two pieces of metadata. In some embodiments, the linking module 210 also may perform a link lookup when a user selects a content item-related piece of data. The link lookup may identify all data linked to the selected data. The identified data may be provided to other modules, such as the navigation module 206, to ensure a seamless pivot navigation experience.

The search module 212 provides an additional mechanism by which a user may discover content. In some embodiments, the search module 212 may include a front-facing search engine component that permits users to enter search queries and retrieve relevant content. In some embodiments, the search module 212 may include a back-end component that performs a search of stored content items and/or content item metadata to identify relevant search results. The search results may be identified in response to a search query or in response to navigation of content by the user.

The user interface generator module 214 generates one or more user interfaces for the application 202. The user interfaces enable a user to browse, search, and navigate among content items. In some embodiments, the user interface generator module 214 may generate a series of user interfaces corresponding to each navigational mode provided by the navigation module 206, as described with reference to the discussion of the navigation module 206.

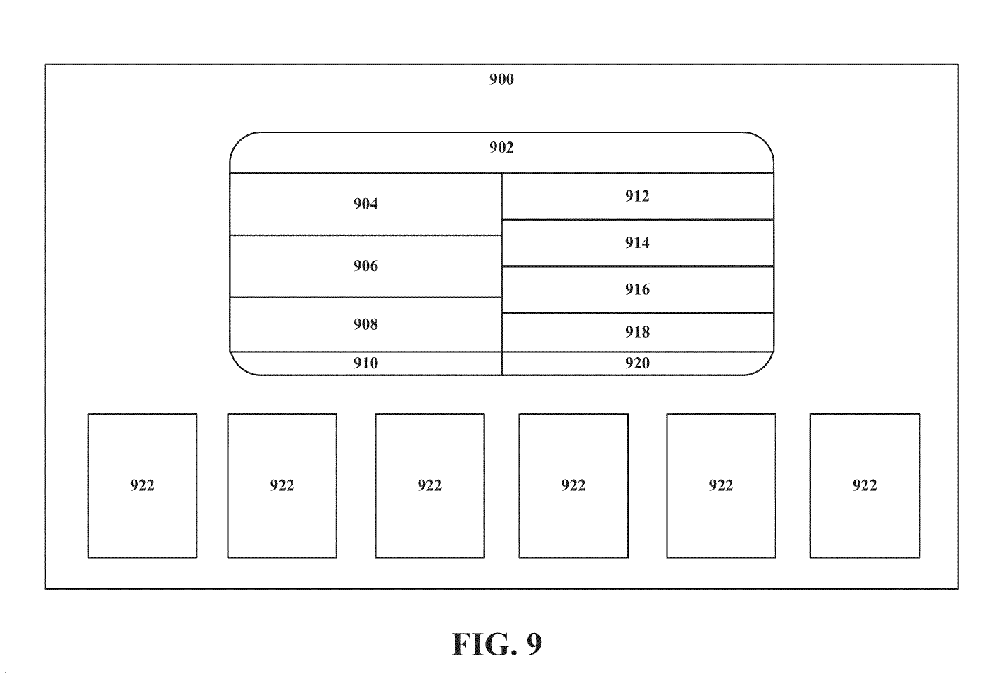

The live TV user interface module 216 provides an additional mechanism by which a user may discover live broadcast content from media channels. For example, instead of browsing through a usual programming grid that displays a grid of content by channels and time, the live TV user interface module 216 replaces the grid with a more intuitive way to browse live media content as described further with respect to FIGS. 9-13. In one embodiment, live content is presented through panels with a time bar indicator for each program to identify the progress of the live programming. For example, half of the time bar indicator may be shaded to represent that the user is about to tune in at about half way through the live content programming. The time bar indicator may be dynamically displayed to represent the amount of time left on the live programming.

The live TV user interface module 216 presents live content categories (e.g., watch now on a channel, favorite channels, movies, sports, news, and so forth) in an upper user interface panel. In one embodiment, after receiving a selection of a live content category, the live TV user interface module 216 displays a lower user interface panel and a time line corresponding to the lower user interface panel. For example, the lower user interface panel may include a first panel representing a live TV programming content that is currently being broadcasted and a second panel representing another live TV programming content that follows the current live TV programming content (e.g., the next immediate show on the same channel). The timeline corresponds to the progress of the current live TV programming content that is currently being broadcasted for the selected channel. For example, the timeline may include a progress indicator, starting time, and ending time of the current live TV programming content. The progress indicator may identify the progress of the current live TV programming content at the time of the user selection of the upper user interface panel. In other words, the progress indicator may graphically display how much of the current live TV programming content has already been broadcasted and how much of the current live TV programming content is left for the user to view. In another example, the progress indicator may include a progress bar, a percentage, or a remaining time.

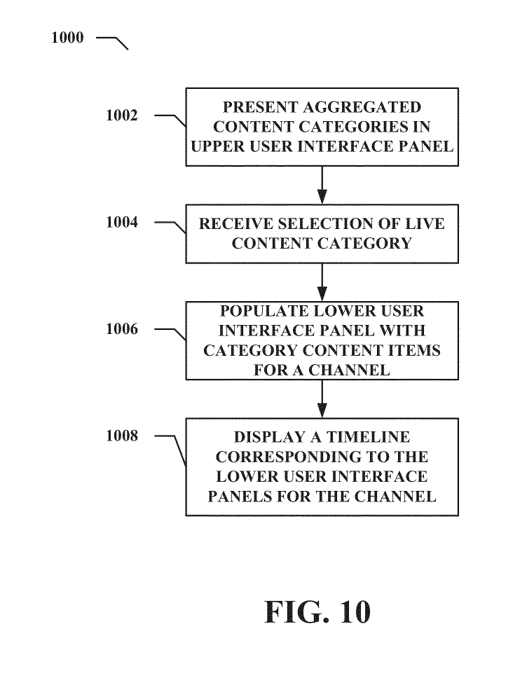

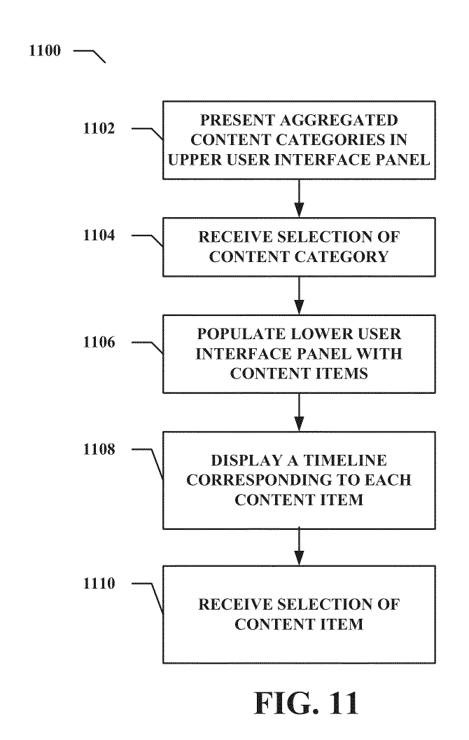

In another embodiment, after receiving a selection of a live content category, the live TV user interface module 216 displays a lower user interface panel and a timeline for each panel of a lower user interface panel. For example, the lower user interface panel may include a panel for each live TV content channel. The panel may include a screenshot or a poster of the live TV content programming. The timeline for each panel corresponds to the progress of the current live TV programming content that is currently being broadcasted for the corresponding channel. For example, the timeline may include a progress indicator, starting time, and ending time of the current live TV programming content. The progress indicator may identify the progress of the current live TV programming content at the time of the user selection of the upper user interface panel. In other words, the progress indicator may graphically display how much of the current live TV programming content has already been broadcasted and how much of the current live TV programming content is left for the user to view. In another example, the progress indicator may include a progress bar, a percentage, or a remaining time. The operation of the live TV user interface module 216 is described in more detail below with respect to FIGS. 10 and 11.

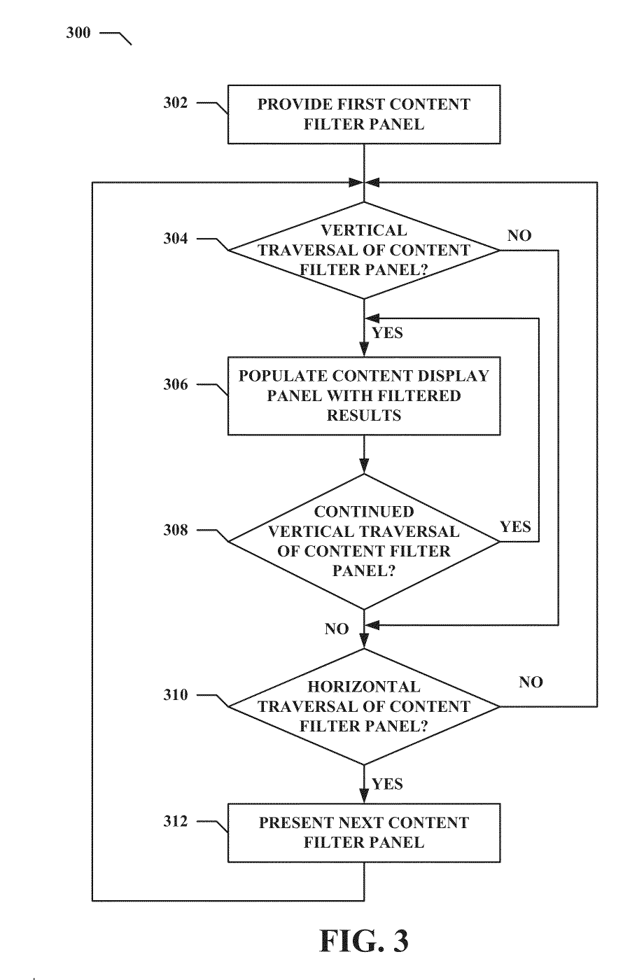

FIG. 3 is a flow diagram illustrating an example method 300 for efficient switching of contexts by which content is navigated, according to some embodiments. Referring to FIG. 3, at block 302, a first content filtering panel is presented in a user interface. The content filtering panel may represent a particular context by which content is to be navigated. The content filtering panel may contain one or more elements therein that represent one or more sub-elements or filters by which to selectively browse content. For example, as previously discussed, a “Top Movies” content filtering panel may include sub-elements “Hottest,” “Newest,” “Top Rated,” “Critics Picks,” and “Top Free.”

At decision block 304, it is determined whether a user is traversing through the content filtering panel in a second axial direction. In some embodiments, the second axis may be the y-axis or a vertical traversal. Vertical traversal may be determined by detecting whether the user is using the up or down arrows of a remote control or keyboard or performing vertically-oriented gestures. If the user is not performing vertical traversal of the content filtering panel, the example method may skip to decision block 310 to determine if the user is performing a horizontal traversal from one content filtering panel to another content filtering panel.

If the user is determined to be vertically traversing the content filtering panel, then at block 306, a content item user interface panel may be populated with content items related to the selected sub-element or filter of the content filtering panel. For example, as the user traverses down the “Top Movies” content filtering panel, the user may highlight a particular sub-element. If the user highlights the “Top Rated” sub-element during vertical traversal, the content item panel may be populated with top rated content items.

At decision block 308, whether or not the user is continuing to vertically traverse through the content filtering panel is determined. If the user is continuing to vertically traverse through the content filtering panel, the example method 300 may return to block 306. If the user is not vertically traversing through the content filtering panel anymore, the example method 300 may proceed to decision block 310.

At decision block 310, whether or not the user is horizontally traversing among content filtering panels is determined. Horizontal traversal (e.g., via the right or left arrows) may correspond to the switching of contexts by which content is browsed. If it is determined that horizontal traversing is not occurring, the example method 300 may return to decision block 304 to determine if vertical traversal within the content filtering panel is occurring. If it is determined that horizontal traversing is occurring, then at block 312, a new content filtering panel is rotated into a centered position of the user interface for traversal by the user.

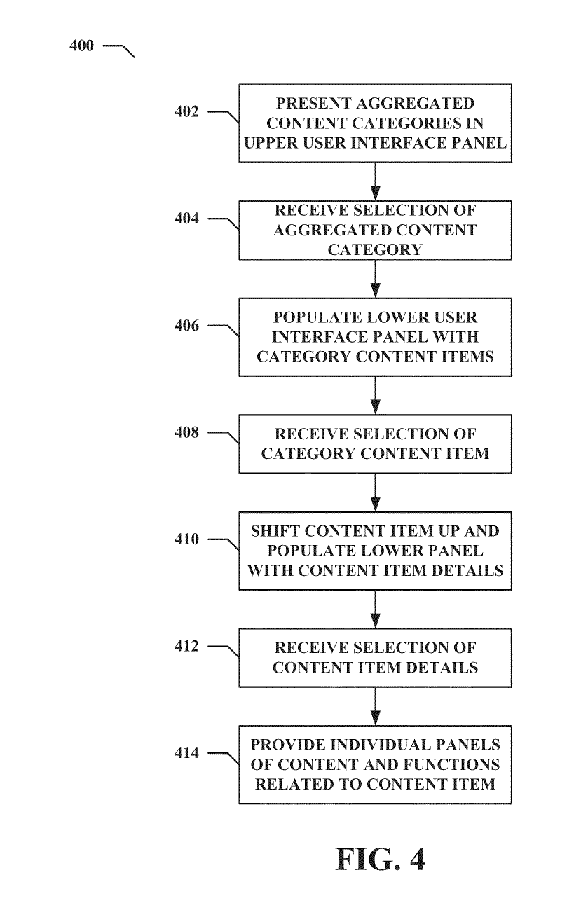

FIG. 4 is a flow diagram illustrating an example method 400 for pyramidal navigation of content, according to some embodiments. Referring to FIG. 4, at block 402, an upper portion of the user interface may display aggregated or high-level content categories in a user interface for an application that facilitates browsing and accessing of content.

At block 404, a selection of a particular content category is received. Receipt of the particular content category may occur via an active selection of the content category such as, for instance, by the user selecting a content category using a remote control, an input device, or a gesture. In some embodiments, receipt of a particular content category may occur simply by the user traversing the presented content categories and highlighting a particular content category with a cursor.

At block 406, a lower portion of the user interface may be populated with content items that relate to the selected content category. In some embodiments, cover art and/or a content item title may be displayed to represent the content items.

At block 408, a selection of a particular content item may be received. The selection of the content item may reflect an interest of the user in the particular selected content item. In some embodiments, a selected content item may be denoted by an indicator that visually emphasizes the selected content item in some respect (e.g., highlighted, enlarging the size of the content item).

At block 410, upon the selection of a content item, the content item display level may transition up the user interface to replace the content category portion previously occupying an upper portion of the user interface. At the same time, the portion of the user interface previously occupied by the displayed content items may be populated with one or more user interface panels that feature information related to a specific content item.

At block 412, the application may receive the selection of the details of the selected content item. This selection may be indicated by the vertical traversal of the cursor from the content item panel of the user interface to the content item detail portion of the user interface.

At block 414, the selection of the details of the selected content item may trigger the user interface generator module 214 to re-generate the user interface of the application to exclusively feature user interface panels directed to different aspects of the content item. As previously discussed, the types of panels related to the content item may be varied, and may include panels such as a cast panel, a content source panel, a merchandise panel, a reviews panel, and a similar content item panel. Browsing among these panels may be accomplished through selection of horizontal direction keys (e.g., left and right arrows) or horizontally-oriented gestures.

As applied to each of the blocks described in the example method 400, traversal of the user interface from one hierarchy to another may be accomplished by a user controlling a cursor using the up or down arrows and progressing from the bottom-most element of one hierarchical level to the top-most element of the next hierarchical level. Traversal among elements of the same hierarchical level may be accomplished using horizontal directional selections (e.g., left or right arrow keys, horizontal gestures).

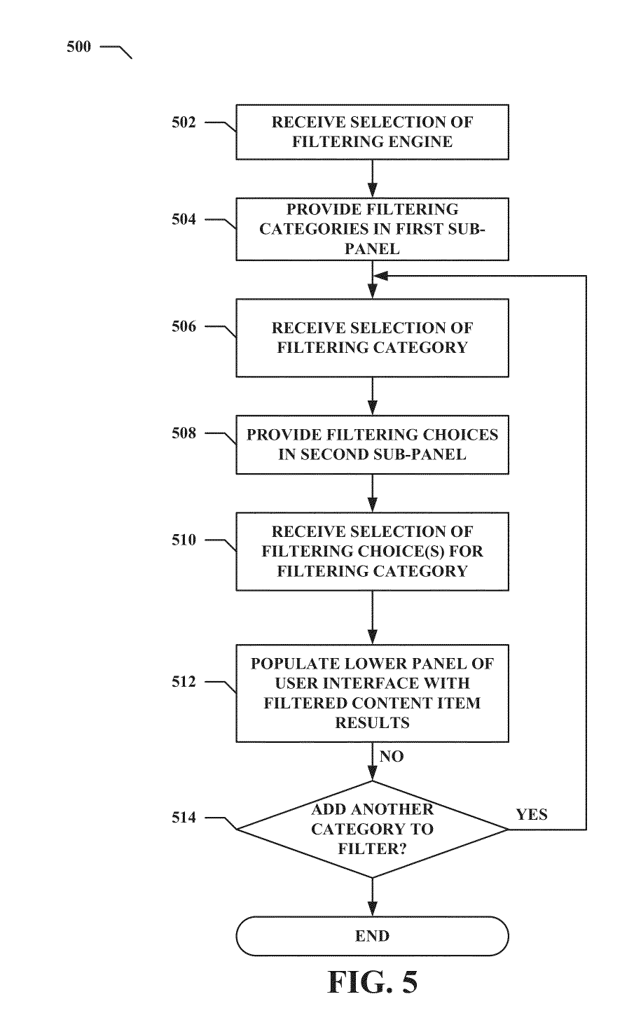

FIG. 5 is a flow diagram illustrating an example method 500 for power browsing of content, according to some embodiments. Referring to FIG. 5, at block 502, a selection to navigate using a power browsing tool is received from a user by the application 202. The power browsing tool may comprise a user interface panel containing sub-panels. A first sub-panel may contain navigable filtering categories, and a second sub-panel may contain navigable filtering options for a selected filtering category.

At block 504, the application 202 may populate the filtering category sub-panel with a set of filtering categories. In some embodiments, the filtering categories may be tailored or specifically selected based on the type of content being browsed. In some embodiments, the user may specify which filtering categories are to be provided in the power browsing tool. In some embodiments, the filtering categories may include user-created filtering categories. The filtering categories may be navigable using direction keys (e.g., arrows) on a user input device (e.g., remote control, keyboard) or by touch-based gestures (e.g., swipes).

At block 506, the application 202 may receive a selection of a filtering category. In some embodiments, the filtering category may be selected merely by navigating to the filtering category, while in other embodiments, the filtering category may be selected by navigating to the filtering category and actively selecting the category itself. As a user navigates among the filtering categories, the navigation indicator may visually emphasize the current location of the indicator. For example, as the user navigates through each listed filtering category, that category may be highlighted, enlarged, or otherwise made noteworthy.

At block 508, upon the selection of a filtering category, the application 202 may direct the user's navigation indicator to a second sub-panel of the power browsing tool to navigate among filtering options for the selected category. The application 202 may populate the second sub-panel with filtering options based on the selected filtering category. In some embodiments, the filter module 208 may receive the selection of the filtering category and may perform a retrieval of the filtering options associated with the filtering category. The filtering options may be provided to the user interface generator module 214 to populate the second sub-panel.

At block 510, the user may select one or more filtering options to apply to the universe of content made accessible by the application 202. For example, if the user selects a filtering category “ratings,” the user may have the option of selecting one or more ratings from the possible ratings “G,” “PG,” “PG-13,” “R,” and “NC-17.”

At block 512, based on the selection of filtering category choices, the application 202 may populate a user interface panel with content items meeting the filtering choices. In some embodiments, the content items may be populated in real-time as filtering choices are selected as opposed to after a user is finished making filtering choices.

At decision block 514, whether or not the user is adding another category to the filter is determined. If the user is adding another category to the filter, the example method 500 may return to block 506. If the user is finished filtering the content, the example method 500 ends.

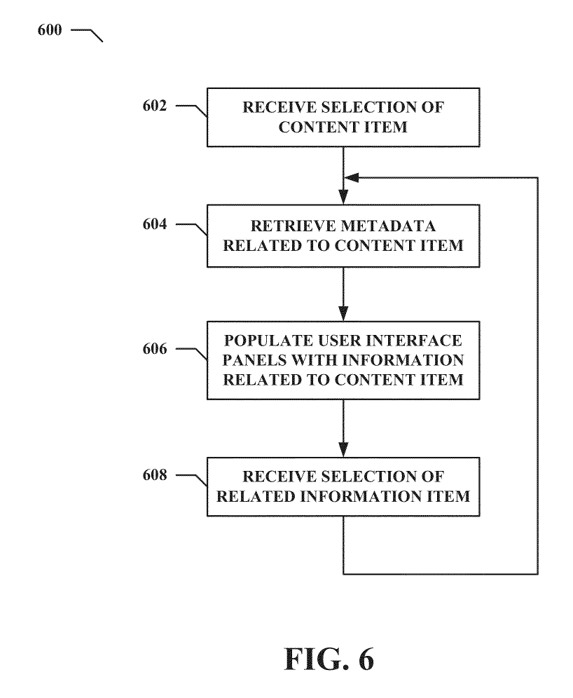

FIG. 6 is a flow diagram illustrating an example method 600 for pivot navigation of content, according to some embodiments. Referring to FIG. 6, at block 602, the application 202 may receive the selection of a content item. The content item may be discovered using one of the navigation methods disclosed herein, may be identified by a search executed by the search module 212, or may be identified using other browsing methodologies.

At block 604, the content retrieval module 204 of the application 202 may retrieve metadata related to the content item in response to receiving the selection of a content item. In some embodiments, the content retrieval module 204 may use a content item identifier to retrieve metadata related to the content item. In some embodiments, metadata related to the content item may be associated with the content item identifier. In some embodiments, the content item identifier may be an identifier used by the application 202 to identify the content item. In the event metadata is to be retrieved from a remote source, the content retrieval module 204 may query a data structure using the application content item identifier to identify an identifier used by the remote source. The remote source identifier may then be used to retrieve content item metadata from the remote source (e.g., via an API call).

At block 606, one or more user interface panels may be populated with information related to the content item. In some embodiments, the user interface panels may be displayed as part of a content detail page that displays information solely related to the selected content item. In some embodiments, each user interface panel may be devoted to a different aspect of the content item. For example, one panel may provide a content item description, while a second panel may provide a listing of the cast of the content item, and a third panel may provide one or more reviews, and so forth. In some embodiments, a user interface panel may be populated by the application 202 only when the panel is actively selected and displayed in order to conserve resources and prevent unnecessary retrieval of metadata.

At block 608, the application 202 may receive a selection of a related information item. For example, when the user is navigating and viewing information related to a selected content item, the user may select a related information item displayed in one of the user interface panels. Selection of the related information item may cause navigation of content to pivot around the selected information item. The example method 600 may return to block 604 to retrieve metadata related to the related information item. In this respect, navigation of content may be pivoted on any displayed information item without having to restart navigation from an initial point.

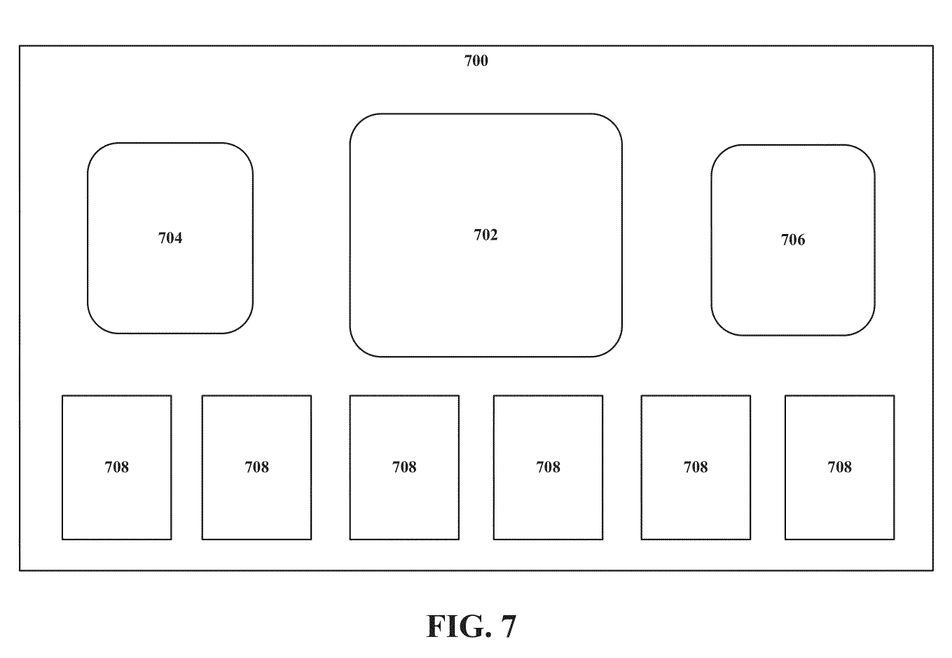

FIG. 7 is a diagram of an example user interface for efficient switching of contexts by which content is navigated, according to some embodiments. In the example user interface 700 of FIG. 7, an upper portion of the user interface 700 may include one or more user interface panels 702, 704, 706. The user interface panels 702, 704, 706 may be rotatable such that one user interface panel 702 is prominently displayed in the center of the user interface 700. Additional user interface panels 704 and 706 may be located on either side of the active user interface panel 702 and may be accessed by traversing in horizontal directions (e.g., left and right) via a user input device or via a touch-based gesture. The user interface panel 702 displayed in the center of user interface 700 may be considered to be the active panel.

Each user interface panel 702, 704, and 706 may contain and display one or more filters (not shown) that may be applied to content to obtain filtered content. The filters contained in each user interface panel 702, 704, and 706 may be navigated by a vertical motion (e.g., up and down arrows) performed on a user input device or by vertical touch-based gestures. As a navigation indicator highlights each filter within a user interface panel, content items 708 displayed in a lower portion of the user interface may update to reflect the results of the filter being highlighted.

In the event the user does not want to filter the displayed content items using a filter contained in the user interface panel 702, the user may rotate the user interface panels 704, 706 to activate either panel 704 or 706. In some embodiments, user interface panels 704 and 706 may filter content according to different contexts. For example, user interface panel 702 may contain filters related to “Top Movies,” while user interface panel 704 may contain filters related to “Genres,” and user interface panel 706 may contain filters related to “Ratings.” Thus, by activating a different user interface panel, the user may switch the context by which content is being filtered.

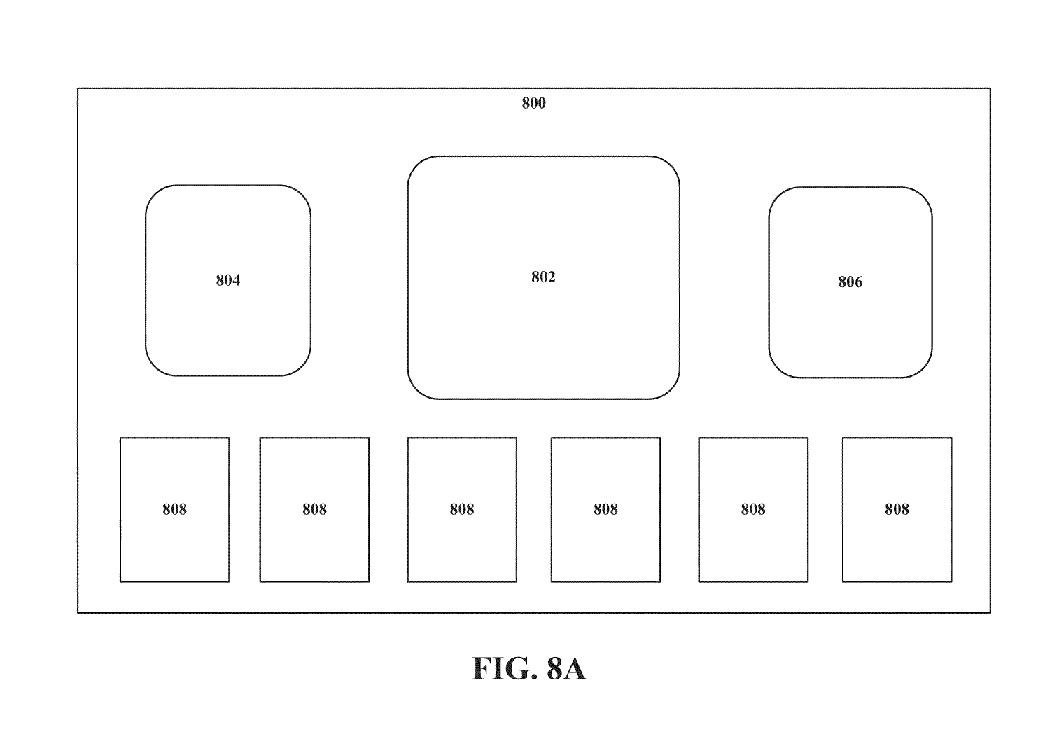

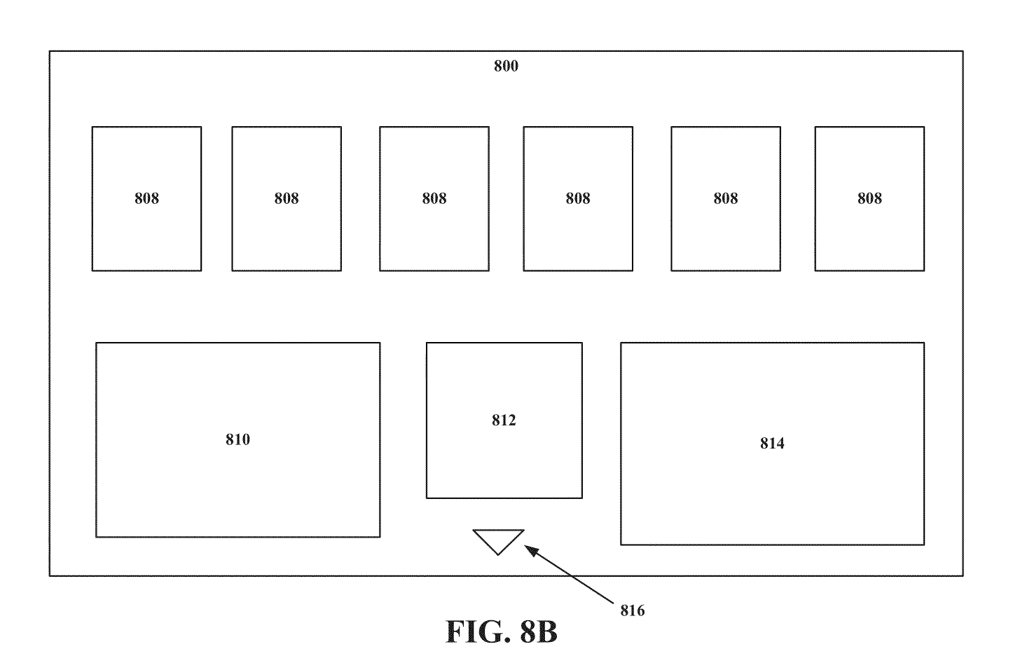

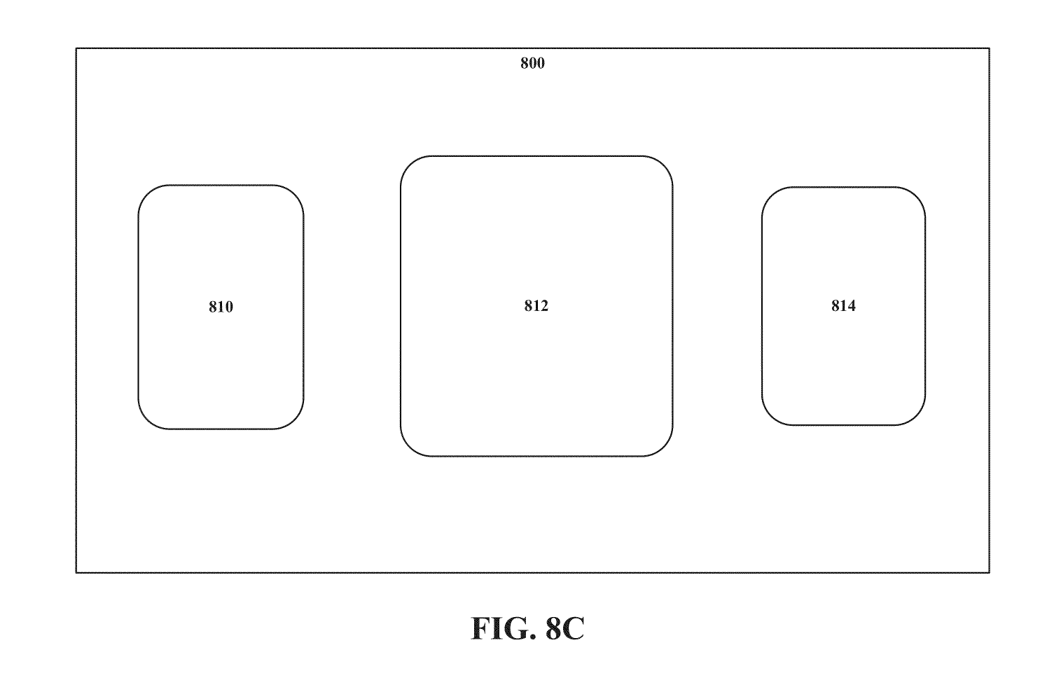

FIG. 8A is a diagram of an example user interface for pyramidal navigation of content, according to some embodiments. Referring to FIG. 8A, a user interface 800 of an application for navigating and viewing content is shown. The user interface 800 may include one or more content filtering panels 802, 804, and 806 and one or more displayed content items 808. Content filtering panels 802, 804, and 806 may be containers that include navigable and selectable filters that may be applied to filter the displayed content items 808. Each content filtering panel 802, 804, and 806 may filter content according to a different context. Displayed content items 808 may be images, such as covers, screenshots, or art work, associated with the content items.

A user may switch content filtering panels 802, 804 and 806 by traversing among the content filtering panels 802, 804, and 806 horizontally (e.g., by using left and right arrows, by using horizontal touch-based gestures, by selecting left and right arrows (not shown) in the user interface 800). Within a content filtering panel 802, 804, and 806, the user may vertically navigate among the different displayed filters to cause the displayed content items 808 to change in response thereto. When the user reaches the last filter contained in a content filtering panel 802, 804, and 806, a further downward action may cause a navigation indicator (e.g., a cursor, a selector, a box) to traverse to the displayed content items 808, such that a user may use the navigation indicator to select a specific displayed content item 808.

FIG. 8B is a diagram of an example user interface for pyramidal navigation of content, according to some embodiments. Referring to FIG. 8B, in response to the navigation indicator selecting or highlighting a displayed content item 808, the user interface 800 may perform a transition whereby the displayed content items 808 are shifted upward to replace the real estate previously occupied by the content filtering panels 802, 804, and 806. Replacing the displayed content items 808 at the lower portion of the user interface 800 may be content item-specific user interface panels 810, 812, and 814. Each content item-specific user interface panel 810, 812, and 814 may be populated with information specific to a selected displayed content item 808. For example, content item-specific user interface panel 810 may display an image or images (e.g., cover art, screenshot, art work) associated with a selected displayed content item 808. Continuing with the example, content item-specific user interface panel 812 may display one or more content sources from which the selected displayed content item 808 may be retrieved and viewed. In continuing with the example, content item-specific user interface panel 814 may display a description of the selected displayed content item 808, such as a plot synopsis or summary. A selectable user interface element, shown as a downward facing arrow 816, in the user interface 800 may instruct the user that further hierarchical or vertical traversal of content is possible.

FIG. 8C is a diagram of an example user interface for pyramidal navigation of content, according to some embodiments. Referring to FIG. 8C, in response to the selection of the arrow 816 shown in FIG. 8B, the user interface 800 may again transition to a state where specific content panels for a single content item are shown. The user interface 800 in this state may be referred to as the Content Details Page. The Content Details Page may depict the same content item-specific user interface panels 810, 812, and 814 shown in FIG. 8B, but with each of the content item-specific user interface panels 810, 812, and 814 enlarged in size and prominently displayed in the user interface 800. As discussed above with respect to the example embodiment of FIG. 8B, the content item-specific user interface panels 810, 812, and 814 may each include information related to a different aspect of a specific content item. The content item-specific user interface panels 810, 812, and 814 may be rotatable such that a user may scroll through the panels to view different informational aspects about the content item. In some embodiments, the content item-specific user interface panels 810, 812, and 814 may include user selectable information elements. For example, if one of the content item-specific user interface panels 810, 812, and 814 contained information about the content sources from which the content item could be retrieved and viewed, each of the content sources listed in the content item-specific user interface panel 810, 812, and 814 may be selectable such that the user would initiate a retrieval of the content item from the selected content source. Additionally, selection of an information element in one of the content item-specific user interface panels 810, 812, and 814 depicted in the Content Detail Page could trigger a pivot navigation flow, whereby navigation would be re-centered and redirected from the selected content item to the selected information element.

It should be appreciated that while discussion has centered on increasing the granularity of content by traversing down a hierarchy of content, a user may similarly navigate upwards to decrease the level of granularity of the information provided with respect to content.

In another embodiment, the content item-specific user interface panels 810, 812, and 814 of FIG. 8C may include, for example, a content item description panel (e.g., description and synopsis of a media content such as a movie or a TV episode), a cast panel listing the cast of the content item (e.g., directors, actors), a content source panel from which the content item can be viewed (e.g., an internet streaming content provider or a cable TV provider), a merchandise panel featuring merchandise related to the content item (e.g., accessories such as T shirts, fashion accessories, toys), a reviews panel featuring reviews of the content item (e.g., reviews from newspapers and magazines), a similar content items panel (e.g., movies of the same genre—action, drama, comedy, etc. . . . ), a video clip content items panel (e.g., video clips, trailers, interviews), a soundtrack panel featuring soundtrack related to the content item (e.g., music, album, artists featured in the movie), a connect panel featuring social networking services for sharing the content item (e.g., posting on a friend's wall, emailing a friend, etc. . . . ), and a news feed panel features news content related to the content items (e.g., news about a director or actor of the movie in the content item).

The application 202 may communicate with a social networking service and log in based on a credential of a user. The application 202 may retrieve likes and dislikes of content such as movies and TV shows from the social network (e.g., friends) of the user. In one embodiment, an indicator may be displayed in the displayed content items 808 of the number of likes and/or dislikes from the social network of the user. In another embodiment, the content item-specific user interface panel 812 includes a connect panel that displays the most liked content items as voted or liked from the social network of the user. For example, the content item-specific user interface panel 812 may display a ranked list of titles of movies that are most liked from the social network of the user.

The application 202 may communicate with at least one news content provider and filter news related to the content items of the corresponding content item-specific user interface panels 810, 812, 814. In one embodiment, the user interface 800 includes an option for a user to indicate that the user likes or is a fan of a particular content item. The news feed panel may then feature news content also related to content items indicated as preferred (e.g., likes, fan of) content items by the user. The user may, thus, follow news about directors or actors of the movies and TV shows that the user has indicated a preference for. The preference indication may also be communicated to the social networking service associated with the user.

The user may navigate between content item-specific user interface panels 810, 812, and 814 using motions in a first axis (e.g., horizontal motions, such as left and right arrow selections, horizontally-directed gestures). If the user selects one of the items displayed in the content item-specific user interface panel 810, 812, and 814 (e.g., a cast member, a merchandise item, a similar content item), the user may be directed to a new hierarchy involving the selected item. This is true for any content item-specific user interface panel 810, 812, and 814. Thus, in this sense, the pyramidal navigation may begin anew and may not be bounded by a start and an end point.

FIG. 9 is a diagram of an example user interface 900 for power browsing of content, according to some embodiments. Referring to FIG. 9, an example user interface 900 containing a power browsing tool 902 is depicted. The power browsing tool 902 may enable a user to filter content according to multiple user-selectable dimensions. The power browsing tool 902 may include a first sub-panel containing filter categories 904, 906, 908, and 910. The filter categories 904, 906, 908, and 910 may be navigable and selectable by a user operating a user input device (e.g., a remote control, a keyboard, a mouse) or by a touch-based gesture. Upon the selection of a filter category, for example, category 904, a navigation indicator (e.g., a cursor, a selector, a box) controlled by the user may be navigated to a second sub-panel containing one or more filter options 912, 914, 916, 918, and 920. The filter options 912, 914, 916, 918, and 920 may be navigated by the user and selected by the user. The power browsing tool 902 may enable a user to select multiple filter options 912, 914, 916, 918, and 920 for a selected filter category (e.g., category 904). As a user selects filter options 912, 914, 916, 918, and 920, content items 922 displayed in the user interface 900 may be updated to reflect the application of the filter options 912, 914, 916, 918, and 920 to the universe of available content.

Upon finishing the selection of filter options 912, 914, 916, 918, and 920 for a particular category, the user may return to the first sub-panel and select a different filter category 904, 906, 908, and 910. The user may select one or more filter options 912, 914, 916, 918, and 920 for the different filter category 904, 906, 908, and 910. The process of selecting a filter category 904, 906, 908, and 910 and filter options 912, 914, 916, 918, and 920 associated therewith may continue until all filter categories 904, 906, 908, and 910 have been selected or until the user has finished selecting filters. Based on the filters selected, the content items 922 displayed in the user interface 900 may be updated to reflect a set of content items 922 that most closely satisfy the filter conditions selected by the user.

FIG. 10 is a flow diagram illustrating an example method 1000 for navigating live content. Referring to FIG. 10, at block 1002, an upper portion of the user interface may display aggregated or high level content categories in a user interface for an application that facilitates browsing and accessing live content.

At block 1004, a selection of a particular content category is received. Receipt of the particular content category may occur via an active selection of the content category, such as for instance, by the user selecting a content category using a remote control, an input device, or a gesture. In some embodiments, receipt of a particular content category may occur simply by the user traversing the presented content categories and highlighting a particular content category with a cursor. Examples of content categories may include live TV, favorite channels, recent channels, watch list, movies, sports, kids, news, family, trending now, friends watching, and top charts.

At block 1006, a lower portion of the user interface may be populated with content items that relate to the selected content category. In some embodiments, cover art and/or a content item title may be displayed to represent the content items. As such, when the user selects the live TV content category, the lower portion of the user interface is populated with the live content programming corresponding to a channel (last channel or default channel). For example, the lower portion of the user interface may include a first panel, a description of the content identified in the first panel, and a second panel. The first panel may include a poster or screenshot of a content being currently broadcast live on the channel. The second panel may include a poster or a screenshot of a content following the end of content of the first panel on the same channel. The description of the content of the first panel may include a title and a short summary or description of the live programming.

At block 1008, a timeline is displayed in the lower portion of the user interface. The timeline may indicate a start time and an end time of the content in the first panel. The timeline may also indicate a start time of the content in the second panel. The timeline may also include a progress indicator to identify how much of the live content is left and how long the live content has been in progress. In one embodiment, the progress indicator may display a colored or grayed bar chart or any other visual indicator. In another embodiment, the progress indicator may display a percentage or a time remaining for the content of the first panel.

Another selection of the particular content category may be received. For example, the user may tap on a remote device again to view the live programming content identified in the first panel.

FIG. 11 is a flow diagram illustrating another example method 1100 for navigating live content. Referring to FIG. 10, at block 1102, an upper portion of the user interface may display aggregated or high-level content categories in a user interface for an application that facilitates browsing and accessing live content.

At block 1104, a selection of a particular content category is received. Receipt of the particular content category may occur via an active selection of the content category, such as for instance, by the user selecting a content category using a remote control, an input device, or a gesture. In some embodiments, receipt of a particular content category may occur simply by the user traversing the presented content categories and highlighting a particular content category with a cursor. Examples of content categories may include live TV, favorite channels, recent channels, watch list, movies, sports, kids, news, family, trending now, friends watching, and top charts.

When the user selects the favorite channels category, the lower portion of the user interface is populated with live content programming of several favorite channels of the user. When the user selects the trending now category, the lower portion of the user interface is populated with live content programming of channels that are currently being viewed the most as determined by the network device 104 of FIG. 1. When the user selects the friends watching category, the lower portion of the user interface is populated with live content programming of channels that are currently being viewed the most by friends of the user of the client device 112 as determined by the network device 104 of FIG. 1. The network device 104 may communicate with an external social network server (not shown) to access information of friends of the user.

At block 1106, the lower portion of the user interface may be populated with content items that relate to the selected content category. In some embodiments, cover art and/or a content item title may be displayed to represent the content items. For example, the lower portion of the user interface may include a plurality of panels. Each panel may include a poster or a screenshot of a live media content corresponding to a medial channel, a channel identifier, and a timeline.

At block 1108, the timeline for each panel is displayed in the lower portion of the user interface. The timeline may indicate a progress of the live content corresponding to a panel. For example, the timeline may include a progress indicator to identify how much of the corresponding live content is left and how long the live content has been in progress. In one embodiment, the progress indicator may display a colored or grayed bar chart or any other visual indicator. In another embodiment, the progress indicator may display a percentage or a time remaining for the content of the first panel.

At block 1110, a selection of a particular live content item may be received. The selection of the content item may reflect an interest of the user in the particular selected content item. In some embodiments, a selected content item may be denoted by an indicator that visually emphasizes the selected content item in some respect (e.g., highlighted, enlarging the size of the content item). The corresponding live media content item is displayed. Browsing among these panels may be accomplished through selection of horizontal direction keys (e.g., left and right arrows) or horizontally-oriented gestures.

As applied to each of the blocks described in the example method 1100, traversal of the user interface from one hierarchy to another may be accomplished by a user controlling a cursor using the up or down arrows and progressing from the bottom-most element of one hierarchical level to the top-most element of the next hierarchical level. Traversal among elements of the same hierarchical level may be accomplished using horizontal directional selections (e.g., left or right arrow keys, horizontal gestures).

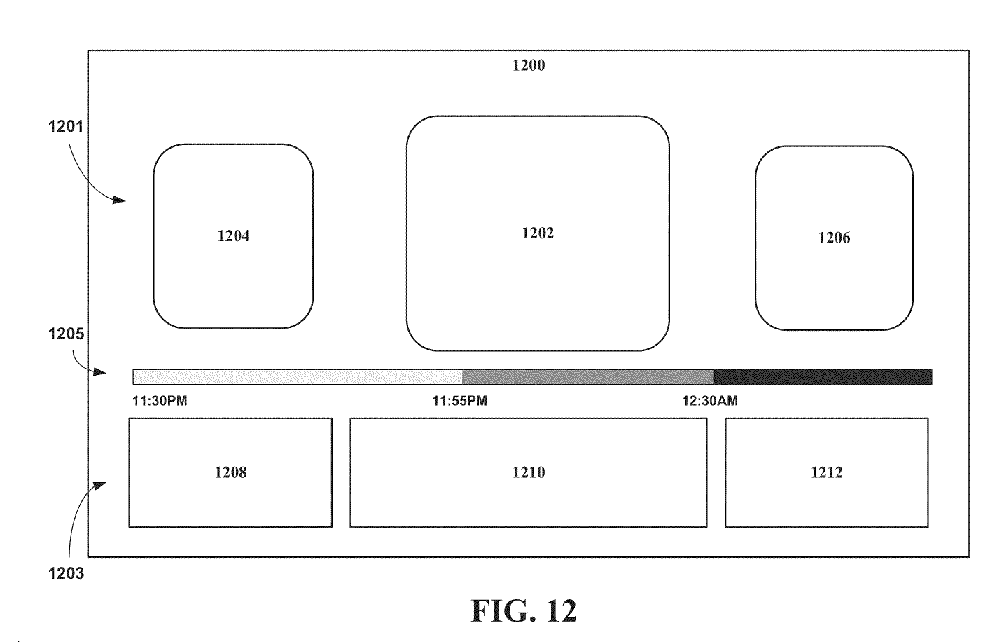

FIG. 12 is a block diagram of an example user interface 1200 for navigating live content. An upper portion 1201 of the user interface 1200 may display aggregated or high level content categories in panels 1202, 1204, and 1206. For example, panel 1202 may include different content categories such as live TV, favorite channels, and news. Upon selection of a content category such as live TV, the content of a live programming of a channel is displayed in a lower portion 1203 of the user interface 1200.

For example, the lower portion 1203 may include a first panel 1208, a description section 1210, and a second panel 1212. The first panel 1208 identifies a live programming content that is currently being broadcasted or on air. The first panel 1208 may include a poster or screenshot of the live programming. The description section 1210 includes a written description of the live programming content identified in the first panel 1208. The second panel 1212 identifies a programming content that is to follow the currently broadcasted live programming content. The second panel 1212 may include a poster or screenshot of the corresponding programming content.

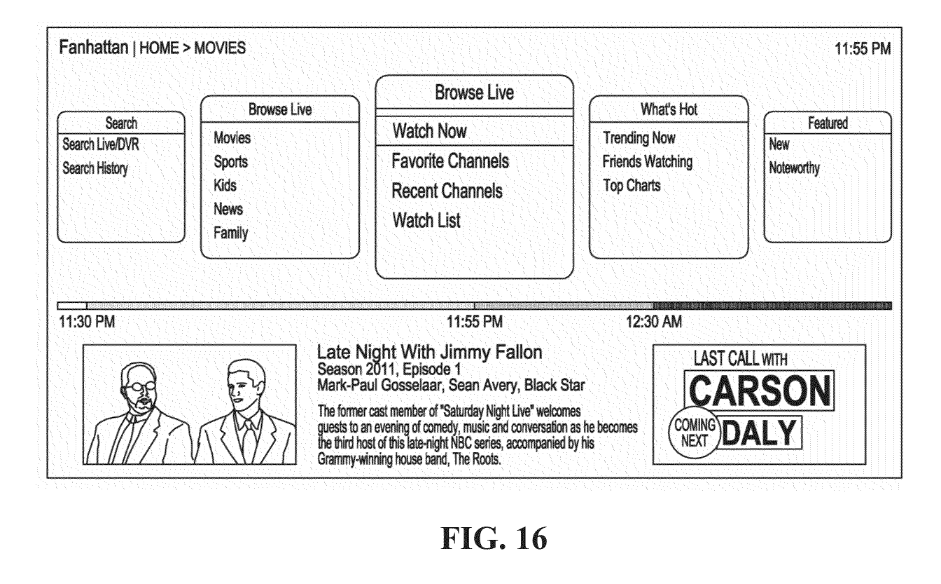

A timeline 1205 may be displayed between the upper portion 1201 and the lower portion 1203 of the user interface 1200. For example, the timeline 1205 may include a start time and an end time of the live programming content identified by the first panel 1208. The timeline 1205 may also include an indicator of the relative progress of the live programming content identified by the first panel 1208. An example embodiment of the user interface 1200 is illustrated in the screenshot of FIG. 16.

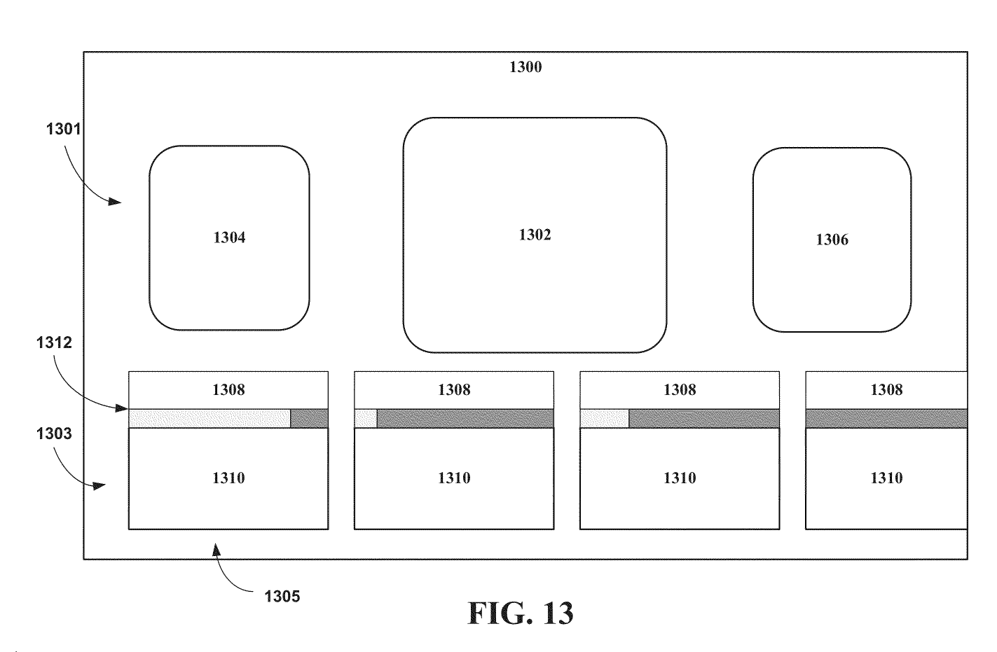

FIG. 13 is a block diagram of another example user interface 1300 for navigating live content. An upper portion 1301 of the user interface 1300 may display aggregated or high level content categories in panels 1302, 1304, and 1306. For example, panel 1302 may include different content categories such as live TV, favorite channels, and news. Upon selection of a content category such as favorite channels, identification of the live programming content for each channel are displayed in a lower portion 1303 of the user interface 1300.

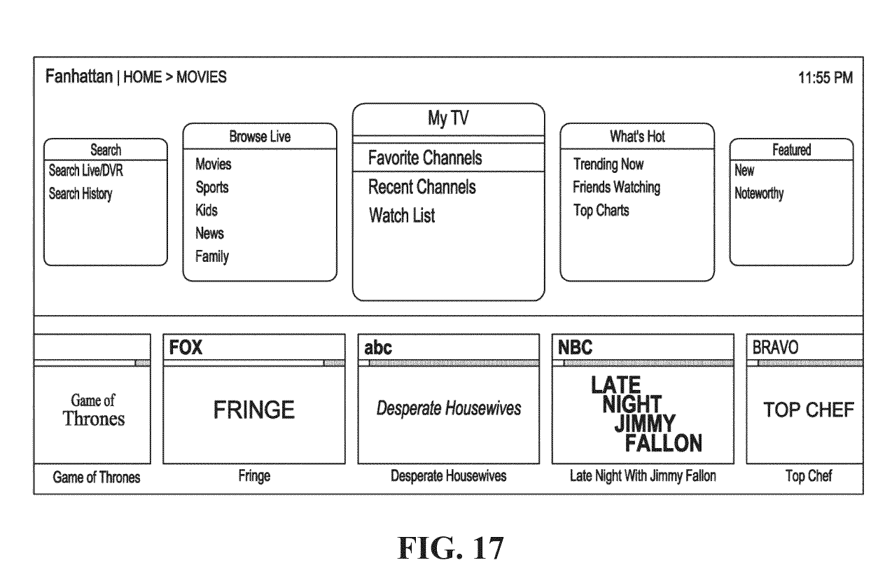

For example, the lower portion 1303 may include a panel 1305 for each channel corresponding to the selected content category. For example, each panel 1305 may include a channel identifier 1308 and a poster or screenshot 1310 identifying the content that is currently being broadcasted on the same channel. Each panel 1305 includes its own corresponding timeline 1312. The timeline 1312 may further indicate the progress of the live programming content on the corresponding channel. For example, the timeline 1312 may include a shaded bar that indicates how much of the live programming content has passed and how much of the live programming content remains. An example embodiment of the user interface 1300 is illustrated in the screenshot of FIG. 17.

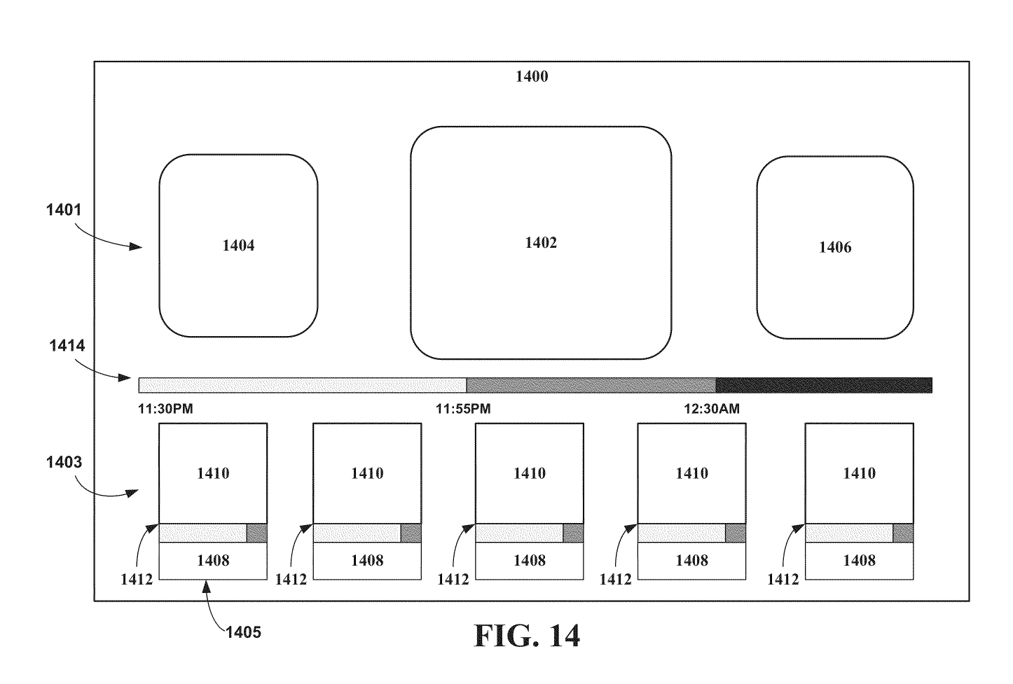

FIG. 14 is a block diagram of another example user interface 1400 for navigating live content. An upper portion 1401 of the user interface 1400 may display aggregated or high level content categories in panels 1402, 1404, and 1406. For example, panel 1402 may include different content categories such as live TV, favorite channels, and news. Upon selection of a content category such as favorite channels, identification of the live programming content for each channel are displayed in a lower portion 1403 of the user interface 1400.

For example, the lower portion 1403 may include a panel 1405 for each channel. For example, each panel 1405 may include a channel identifier 1408 and a poster or screenshot 1410 identifying the content that is currently being broadcasted on the same channel. Each panel 1405 includes its own corresponding timeline 1412. The timeline 1412 may further indicate the progress of the live programming content on the corresponding channel. For example, the timeline 1412 may include a shaded bar that indicates how much of the live programming content has passed and how much of the live programming content remains.

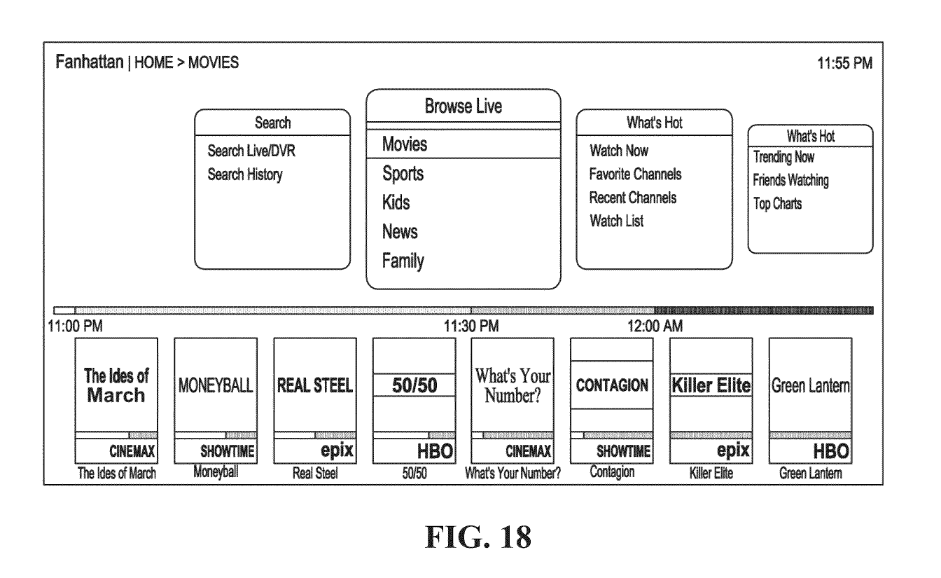

In addition, another timeline 1414 is displayed to provide a time reference to the user. For example, the timeline 1414 may be segmented by the hour or half hour. The timeline 1414 may include a progress indicator to show the user how much time has elapsed past the hour or the half hour. An example embodiment of the user interface 1400 is illustrated in the screenshot of FIG. 18.

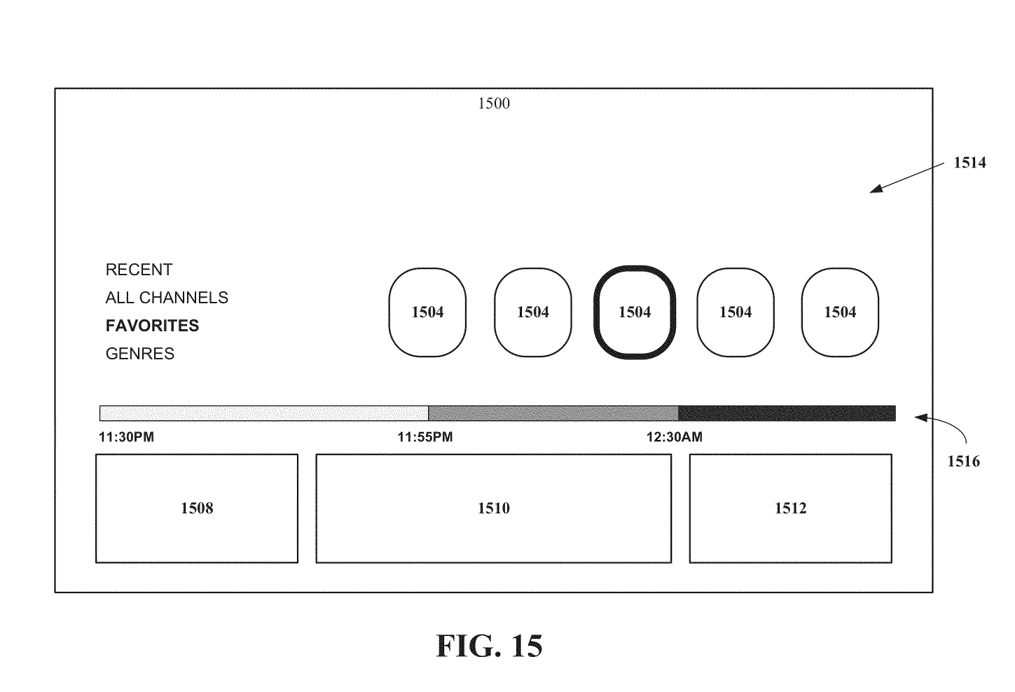

FIG. 15 is a block diagram of another example user interface 1500 for navigating live content. The user interface 1500 includes a carrousel of panels 1514 where each panel 1504 corresponds to a media channel. The carrousel of panels 1514 corresponds to a selected content category (e.g., recent, all channels, favorites, genres).

A lower portion of the user interface 1500 includes a first panel 1508, a description section 1510, and a second panel 1512. The first panel 1508 identifies a live programming content that is currently being broadcasted or on air on the corresponding channel of a selected panel 1504. The first panel 1508 may include a poster or screenshot of the live programming. The description section 1510 includes a written description of the live programming content identified in the first panel 1508. The second panel 1512 identifies a programming content that is to follow the currently broadcasted live programming content. The second panel 1512 may include a poster or screenshot of the corresponding programming content.

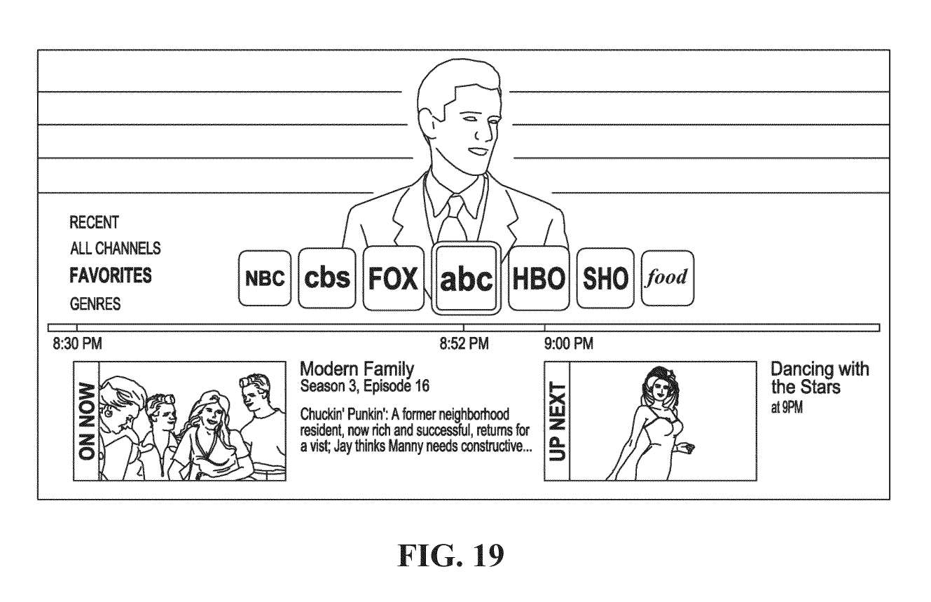

The user interface 1500 may also include a timeline 1516 displayed to provide a time reference to the user. For example, the timeline 1516 may be segmented by the hour or half hour. The timeline 1516 may include a progress indicator to show the user how much time has elapsed past the hour or the half hour. The combined width of the first panel 1508 and the description section 1510 matches a corresponding width in the timeline 1516. For example, the live programming content of the first panel 1508 starts at 11:30 pm and ends at 12:30 am. As such, the combined width of the first panel 1508 and the description section 1510 fit within the corresponding length on the timeline 1516. The programming content of the second panel 1512 starts at 12:30 am. As such, the second panel 1512 is displayed and positioned to correspond to the 12:30 am time on the timeline 1516. An example embodiment of the user interface 1500 is illustrated in the screenshot of FIG. 19.

It should be appreciated that the dimensions and placement of the user interfaces and its elements as depicted in the foregoing embodiments are not to be construed as limiting for the purposes of the discussion herein.

### Modules, Components and Logic

Certain embodiments are described herein as including logic or a number of components, modules, or mechanisms. A component or module is a non-transitory and tangible unit capable of performing certain operations and may be configured or arranged in a certain manner. In example embodiments, one or more computer systems (e.g., a standalone, client, or server computer system) or one or more components of a computer system (e.g., a processor or a group of processors) may be configured by software (e.g., an application or application portion) as a component that operates to perform certain operations as described herein.

In various embodiments, a component or a module may be implemented mechanically or electronically. For example, a component or a module may comprise dedicated circuitry or logic that is permanently configured (e.g., as a special-purpose processor) to perform certain operations. A component or a module may also comprise programmable logic or circuitry (e.g., as encompassed within a general-purpose processor or other programmable processors) that is temporarily configured by software to perform certain operations. It will be appreciated that the decision to implement a component mechanically, in dedicated and permanently configured circuitry, or in temporarily configured circuitry (e.g., configured by software) may be driven by cost and time considerations.

Accordingly, the term “component” or “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which components or modules are temporarily configured (e.g., programmed), each of the components or modules need not be configured or instantiated at any one instance in time. For example, where the components or modules comprise a general-purpose processor configured using software, the general-purpose processor may be configured as respective different components at different times. Software may, accordingly, configure a processor, for example, to constitute a particular component or module at one instance of time and to constitute a different component or module at a different instance of time.

Components or modules can provide information to, and receive information from, other components or modules. Accordingly, the described components may be regarded as being communicatively coupled. Where multiple of such components or modules exist contemporaneously, communications may be achieved through signal transmission (e.g., over appropriate circuits and buses) that connect the components or modules. In embodiments in which multiple components or modules are configured or instantiated at different times, communications between such components or modules may be achieved, for example, through the storage and retrieval of information in memory structures to which the multiple components or modules have access. For example, one component or module may perform an operation and store the output of that operation in a memory device to which it is communicatively coupled. A further component or module may then, at a later time, access the memory device to retrieve and process the stored output. Components or modules may also initiate communications with input or output devices, and can operate on a resource (e.g., a collection of information).

### Electronic Apparatus and System

Example embodiments may be implemented in digital electronic circuitry, or in computer hardware, firmware, software, or in combinations of them. Example embodiments may be implemented using a computer program product (e.g., a computer program tangibly embodied in an information carrier, e.g., in a machine-readable medium for execution by, or to control the operation of, data processing apparatus, e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA (field programmable gate array) or an ASIC (application-specific integrated circuit).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

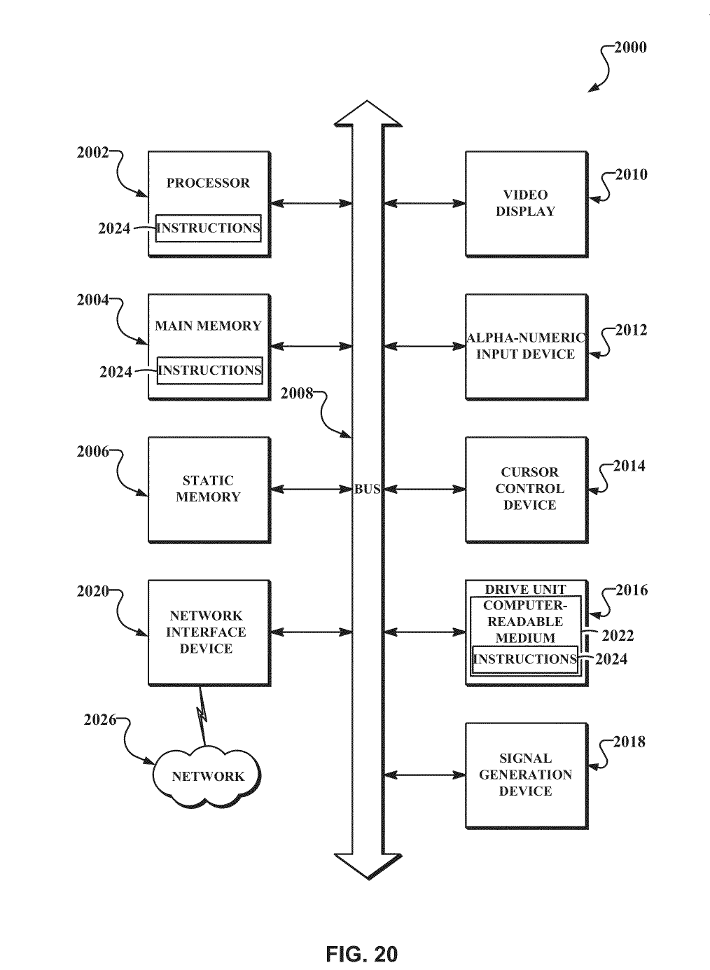

FIG. 20 is a block diagram of machine in the example form of a computer system 2000 within which instructions 2024, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment. The machine may be a personal computer (PC), a tablet PC, a set-top box (STB), a Personal Digital Assistant (PDA), a cellular telephone, a web appliance, a network router, switch or bridge, or any machine capable of executing instructions 2024 (sequential or otherwise) that specify actions to be taken by that machine. Further, while only a single machine is illustrated, the term “machine” shall also be taken to include any collection of machines that, individually or jointly, execute a set (or multiple sets) of instructions 2024 to perform any one or more of the methodologies discussed herein.

The example computer system 2000 includes at least one processor 2002 (e.g., a central processing unit (CPU), a graphics processing unit (GPU) or both), a main memory 2004 and a static memory 2006, which communicate with each other via a bus 2008. The computer system 2000 may further include a video display unit 2010 (e.g., a liquid crystal display (LCD) or a cathode ray tube (CRT)). The computer system 2000 also includes an alphanumeric input device 2012 (e.g., a keyboard), a user interface (UI) navigation device 2014 (e.g., a mouse), a disk drive unit 2016, a signal generation device 2018 (e.g., a speaker) and a network interface device 2020.

### Machine-Readable Medium

The drive unit 2016 includes a machine-readable medium 2022 on which is stored one or more sets of instructions 2024 and data structures (e.g., software) embodying or utilized by any one or more of the methodologies or functions described herein. The software 2024 may also reside, completely or at least partially, within the main memory 2004 and/or within the processor 2002 during execution thereof by the computer system 2000, the main memory 2004 and the processor 2002 also constituting machine-readable media.

While the machine-readable medium 2022 is shown in an example embodiment to be a single medium, the term “machine-readable medium” may include a single medium or multiple media (e.g., a centralized or distributed database, and/or associated caches and servers) that store the one or more instructions 2024 or data structures. The term “machine-readable medium” shall also be taken to include any non-transitory tangible medium that is capable of storing, encoding or carrying instructions 2024 for execution by the machine and that cause the machine to perform any one or more of the methodologies of the present invention, or that is capable of storing, encoding or carrying data structures utilized by or associated with such instructions 2024. The term “machine-readable medium” shall, accordingly, be taken to include, but not be limited to, solid-state memories, and optical and magnetic media. Specific examples of machine-readable media 2022 include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

### Transmission Medium

The software 2024 may further be transmitted or received over a communications network 2026 using a transmission medium. The software 2024 may be transmitted using the network interface device 2020 and any one of a number of well-known transfer protocols (e.g., HTTP). Examples of communication networks 2026 include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions 2024 for execution by the machine, and includes digital or analog communications signals or other intangible medium to facilitate communication of such instructions 2024.

### Example Three-Tier Software Architecture

In some embodiments, the described methods may be implemented using a distributed or non-distributed software application designed under a three-tier architecture paradigm. Under this paradigm, various parts of computer code (or software) that instantiate or configure components or modules may be categorized as belonging to one or more of these three tiers. Some embodiments may include a first tier as an interface (e.g., an interface tier). Further, a second tier may be a logic (or application) tier that performs application processing of data inputted through the interface level. The logic tier may communicate the results of such processing to the interface tier, and/or to a backend, or storage tier. The processing performed by the logic tier may relate to certain rules or processes that govern the software as a whole. A third storage tier may be a persistent storage medium or a non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. The three-tier architecture may be implemented using one technology or a variety of technologies. The example three-tier architecture and the technologies through which it is implemented, may be realized on one or more computer systems operating, for example, as a standalone system, or organized in a server-client, distributed or in some other suitable configuration. Further, these three tiers may be distributed between more than one computer systems as various components.

### Components

Example embodiments may include the above-described tiers, and processes or operations about constituting these tiers may be implemented as components. Common to many of these components is the ability to generate, use, and manipulate data. The components and the functionality associated with each may form part of standalone, client, or server computer systems. The various components may be implemented by a computer system on an as-needed basis. These components may include software written in an object-oriented computer language, such that a component oriented or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable techniques.

Software for these components may further enable communicative coupling to other components (e.g., via various Application Programming interfaces (APIs)), and may be compiled into one complete server and/or client software application. Further, these APIs may be able to communicate through various distributed programming protocols as distributed computing components.

### Distributed Computing Components and Protocols

Some example embodiments may include remote procedure calls being used to implement one or more of the above described components across a distributed programming environment as distributed computing components. For example, an interface component (e.g., an interface tier) may form part of a first computer system that is remotely located from a second computer system containing a logic component (e.g., a logic tier). These first and second computer systems may be configured in a standalone, server-client, or some other suitable configuration. Software for the components may be written using the above described object-oriented programming techniques, and can be written in the same programming language, or a different programming language. Various protocols may be implemented to enable these various components to communicate regardless of the programming language used to write these components. For example, a component written in C++ may be able to communicate with another component written in the Java programming language through utilizing a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model, or Transmission Control Protocol/Internet Protocol (TCP/IP) protocol stack model for defining the protocols used by a network to transmit data.

### A System of Transmission Between a Server and Client

Example embodiments may use the OSI model or TCP/IP protocol stack model for defining the protocols used by a network to transmit data. In applying these models, a system of data transmission between a server and client may, for example, include five layers comprising: an application layer, a transport layer, a network layer, a data link layer, and a physical layer. In the case of software for instantiating or configuring components having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data is transmitted over a network such as an Internet, Local Area Network (LAN), Wide Area Network (WAN), or some other suitable network. In some cases, Internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology), or structures.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof show by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
at least one processor; and
a live media user interface module implemented by the at least one processor, configured to:
populate a top portion of a user interface with a plurality of media content categories;
receive a selection of a media content category from the plurality of media content categories;
populate a bottom portion of the user interface with at least one panel relating to the selection of media content category; and
generate a timeline comprising a progress indicator corresponding to a progress of a live media content associated with the at least one panel.

2. The system of claim 1, wherein the selection of the media content category includes a live media channel,
wherein the bottom portion of the user interface comprises:
a first panel including an image related to a live media content of the live media channel;
a description section including a written description of the live media content identified in the first panel; and
a second panel including an image related to a next media content following the live media content;
the timeline comprising a start time and an end time of the live media content of the live media channel, the progress indicator identifying the progress of the live media content between the start time and the end time, a combined width of the first panel and the description section substantially equal to the length of a portion of the timeline between the start time and the end time, the second panel disposed adjacent to a portion of the timeline after the end time of the live media content.

3. The system of claim 1, wherein the selection of the media content category includes a plurality of live media channels,
wherein the bottom portion of the user interface comprises a plurality of panels, each panel corresponding to a channel from the plurality of live media channels, each panel comprising a live media channel identifier, a poster of the live media content on the corresponding live media channel, and a channel timeline including a channel progress indicator corresponding to a progress of the live media content on the corresponding live media channel.

4. The system of claim 3, wherein the channel timeline is disposed between the top portion of the user interface and the bottom portion of the user interface, the channel timeline including a start time and an end time of the live media content of a live media channel, the channel progress indicator identifying the progress of the live media content between the start time and the end time.

5. The system of claim 1, wherein the top portion of the user interface includes a horizontal carousel of a plurality of live media channel identifiers.

6. The system of claim 1, wherein the top portion of the user interface includes a horizontal carousel of a plurality of a plurality of panels, each panel comprising the plurality of media content categories.

7. The system of claim 1, wherein the timeline comprises a progress indicator corresponding to a progress of a live media content associated with the at least one panel.

8. The system of claim 3, wherein the bottom portion of the user interface comprises a horizontal carousel including the plurality of panels.

9. The system of claim 1, further comprising:
a user interface generator module configured to:
receive a second selection of a media content category from the plurality of media content categories; and
shift media content items from the bottom portion of the user interface to the top portion of the user interface.

10. The system of claim 9, wherein the user interface generator module is configured to populate the bottom portion of the user interface with:
a first panel including an image related to a live media content of a live media channel;
a description section including a written description of the live media content identified in the first panel;
a second panel including an image related to a next media content following the live media content; and
a timeline comprising a start time and an end time of the live media content of the live media channel, a progress indicator identifying a progress of the live media content between the start time and the end time, a combined width of the first panel and the description section substantially equal to a length of a portion of the timeline between the start time and the end time, the second panel disposed adjacent to a portion of the timeline after the end time of the live media content.

11. A method comprising:
populating a top portion of a user interface with a plurality of media content categories;
receiving a selection of a media content category from the plurality of media content categories;
populating a bottom portion of the user interface with at least one panel relating to the selection of media content category; and
generating a timeline comprising a progress indicator corresponding to a progress of a live media content associated with the at least one panel.

12. The method of claim 11, wherein the selection of the media content category includes a live media channel,
wherein the bottom portion of the user interface comprises:
a first panel including an image related to a live media content of the live media channel;
a description section including a written description of the live media content identified in the first panel;
a second panel including an image related to a next media content following the live media content; and
the timeline comprising a start time and an end time of the live media content of the live media channel, the progress indicator identifying a progress of the live media content between the start time and the end time, a combined width of the first panel and the description section substantially equal to a length of a portion of the timeline between the start time and the end time, the second panel disposed adjacent to a portion of the timeline after the end time of the live media content.

13. The method of claim 11, wherein the selection of the media content category includes a plurality of live media channels; and
wherein the bottom portion of the user interface comprises a plurality of panels, each panel corresponding to a channel from the plurality of live media channels, each panel comprising a live media channel identifier, a poster of the live media content on the corresponding live media channel, and a channel timeline including a channel progress indicator corresponding to a progress of the live media content on the corresponding live media channel.

14. The method of claim 13, further comprising:
disposing the timeline between the top portion of the user interface and the bottom portion of the user interface, the timeline including a start time and an end time of the live media content of a live media channel, the channel progress indicator identifying the progress of the live media content between the start time and the end time.

15. The method of claim 11, wherein the top portion of the user interface includes a horizontal carousel of a plurality of live media channel identifiers.

16. The method of claim 11, wherein the top portion of the user interface includes a horizontal carousel of a plurality of a plurality of panels, each panel comprising the plurality of media content categories.

17. The method of claim 11, wherein the timeline comprises a progress indicator corresponding to a progress of a live media content associated with the at least one panel.

18. The method of claim 13, wherein the bottom portion of the user interface comprises a horizontal carousel including the plurality of panels.

19. The method of claim 11, further comprising:
receiving a second selection of a media content category from the plurality of media content categories;
shifting media content items from the bottom portion of the user interface to the top portion of the user interface; and
populating the bottom portion of the user interface with:
a first panel including an image related to a live media content of a live media channel;
a description section including a written description of the live media content identified in the first panel;
a second panel including an image related to a next media content following the live media content; and
the timeline comprising a start time and an end time of the live media content of the live media channel, the progress indicator identifying a progress of the live media content between the start time and the end time, a combined width of the first panel and the description section substantially equal to a length of a portion of the timeline between the start time and the end time, the second panel disposed adjacent to a portion of the timeline after the end time of the live media content.

20. A non-transitory machine-readable storage medium storing a set of instructions that, when executed by at least one processor, causes the at least one processor to perform operations comprising:
populating a top portion of a user interface with a plurality of media content categories;
receiving a selection of a media content category from the plurality of media content categories;
populating a bottom portion of the user interface with at least one panel relating to the selection of media content category; and
generating a timeline comprising a progress indicator corresponding to a progress of a live media content associated with the at least one panel.
